(19) United States
(12) Patent Application Publication
(10) Pub. No.: US 2007/0126146 A1
(43) Pub. Date: Jun. 7, 2007

(54) Method for manufacturing composite shoe insole

(76) Inventor: Kuo-Nan Yang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/294,594

(22) Filed: Dec. 5, 2005

(51) Int. Cl. B29C 41/22; B29C 41/42

(52) U.S. Cl. 264/259; 264/334

(57) ABSTRACT

A method for manufacturing a composite shoe insole includes a) placing EVA material having at least one bonding zone into a die, b) applying a PU film around a peripheral wall of the bonding zone of the EVA material, c) heating the EVA material, d) placing PU material at a liquid state into the bonding zone, e) solidifying the PU material so that the PU material is combined with the bonding zone to form a shoe insole, and f) stripping the shoe insole from the die to remove the shoe insole. Thus, the composite shoe insole closely combine the EVA material with the PU material, so that the composite shoe insole has a lighter weight by the EVA material and has a soft elastic feature by the PU material.

### BACKGROUND OF THE INVENTION

1. Field of the Invention

The present invention relates to a method for manufacturing a shoe insole and, more particularly, to a method for manufacturing a composite shoe insole.

2. Description of the Related Art

A conventional shoe insole is made of PU material that has a soft elastic feature to provide a greater elastic support to a user's foot, thereby providing a comfortable sensation to the user. However, the PU material has a heavier weight, thereby increasing the burden to the user. In addition, the PU material easily produces powder when touching the water, thereby weakening or breaking the structure of the shoe insole.

Another conventional shoe insole is made of EVA material that has a lighter weight so as to reduce the whole weight of the shoe insole, thereby decreasing the burden to the user. However, the EVA material has a smaller elasticity, thereby easily causing an uncomfortable sensation to the user.

### SUMMARY OF THE INVENTION

In accordance with the present invention, there is provided a method for manufacturing a composite shoe insole, comprising a) placing EVA material into a die, wherein the EVA material has at least one bonding zone, b) applying a PU film around a peripheral wall of the bonding zone of the EVA material, c) heating the EVA material, d) placing PU material at a liquid state into the bonding zone of the EVA material, e) solidifying the PU material so that the PU material is combined with the bonding zone of the EVA material to form a shoe insole, and f) stripping the shoe insole from the die to remove the shoe insole which combines the EVA material and the PU material.

The primary objective of the present invention is to provide a method for manufacturing a composite shoe insole that closely combine the EVA material with the PU material, so that the composite shoe insole has a lighter weight by the EVA material and has a soft elastic feature by the PU material.

Another objective of the present invention is to provide a method for manufacturing a composite shoe insole, wherein the solid PU material of the shoe insole provides a greater elastic support to a user's foot, thereby providing a comfortable sensation to the user.

A further objective of the present invention is to provide a method for manufacturing a composite shoe insole, wherein the EVA material of the shoe insole has a lighter weight to reduce the whole weight of the shoe insole, thereby decreasing the burden to the user.

A further objective of the present invention is to provide a method for manufacturing a composite shoe insole, wherein the proportion, position and size of the EVA material and the PU material can be changed according to the practical requirement so as to provide a comfortable sensation to the user and to reduce the whole weight of the shoe insole, thereby enhancing the versatility of the shoe insole.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of method for manufacturing a composite shoe insole in accordance with the preferred embodiment of the present invention.

FIG. 2 is an exploded perspective view of a composite shoe insole in accordance with the preferred embodiment of the present invention.

FIG. 3 is a plan cross-sectional assembly view of the composite shoe insole as shown in FIG. 1.

FIG. 4 is an exploded perspective view of a composite shoe insole in accordance with another preferred embodiment of the present invention.

FIG. 5 is a plan cross-sectional assembly view of the composite shoe insole as shown in FIG. 4.

FIG. 6 is an exploded perspective view of a composite shoe insole in accordance with another preferred embodiment of the present invention.

FIG. 7 is a plan cross-sectional assembly view of the composite shoe insole as shown in FIG. 6.

FIG. 8 is an exploded perspective view of a composite shoe insole in accordance with another preferred embodiment of the present invention.

FIG. 9 is a plan cross-sectional assembly view of the composite shoe insole as shown in FIG. 8.

FIG. 10 is a flow chart of method for manufacturing a composite shoe insole in accordance with another preferred embodiment of the present invention.

### DETAILED DESCRIPTION OF THE INVENTION

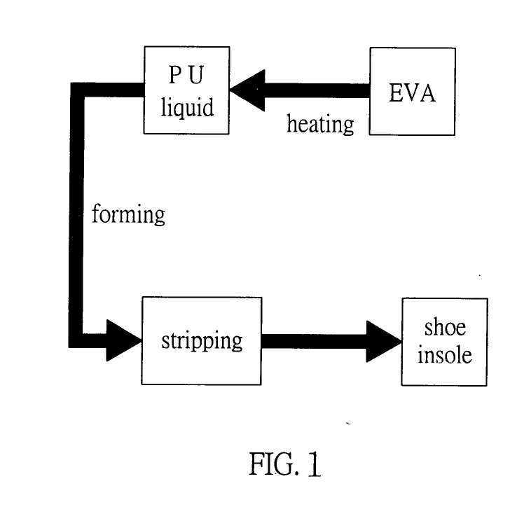

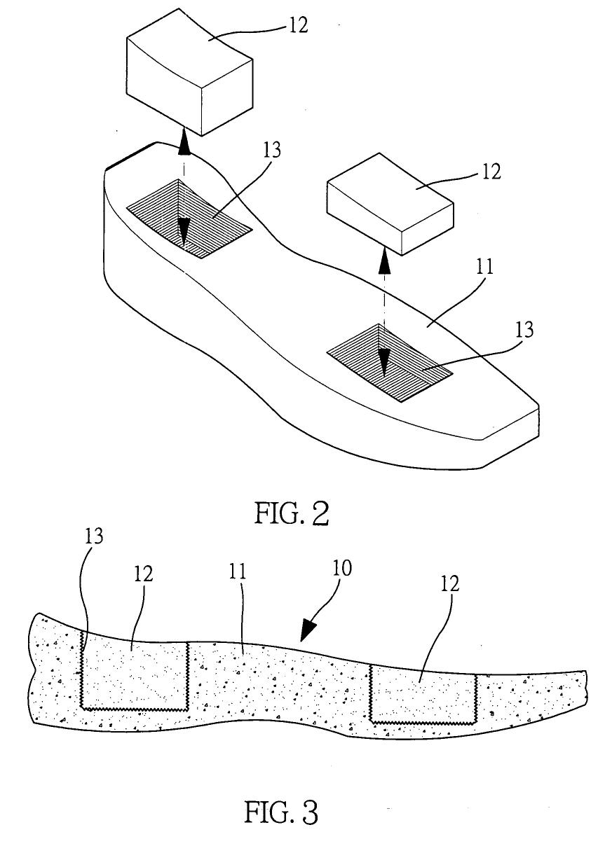

Referring to the drawings and initially to FIGS. 1-3, a method for manufacturing a composite shoe insole in accordance with the preferred embodiment of the present invention comprises the following steps:

a) placing EVA (ethyl vinyl acetate) material 11 into a die, wherein the EVA material 11 has at least one bonding zone 13;

b) applying a PU (polyurethane) film around a peripheral wall of the bonding zone 13 of the EVA material 11;

c) heating the EVA material 11 to a temperature at about 50° C. to 60° C.;

d) placing PU material 12 at a liquid state into the bonding zone 13 of the EVA material 11;

e) solidifying the PU material 12 so that the PU material 12 is combined with the bonding zone 13 of the EVA material 11 to form a shoe insole 10;

f) stripping the shoe insole 10 from the die to remove the shoe insole 10 which combines the EVA material 11 and the PU material 12.

In the preferred embodiment of the present invention, the PU material 12 is combined with the bonding zone 13 of the EVA material 11 by the PU film which functions as a bonding interface between the PU material 12 and the bonding zone 13 of the EVA material 11, so that the PU material 12 is combined with the EVA material 11 closely. In addition, the bonding zone 13 is a recess which is formed in an inside of the EVA material 11 and is not extended through a whole thickness of the EVA material 11, and the peripheral wall of the bonding zone 13 of the EVA material 11 has a rough surface, and the PU film is applied onto the rough surface of the bonding zone 13 of the EVA material 11. Preferably, the EVA material 11 has two substantially rectangular bonding zones 13 located at front and rear portions of the EVA material 11 respectively, so that two solid PU materials 12 are located at the front and rear portions of the EVA material 11 respectively.

Thus, the two solid PU materials 12 of the shoe insole 10 provide a greater elastic support to the front and rear portions of a user's foot, thereby providing a comfortable sensation to the user. In addition, the EVA material 11 of the shoe insole 10 has a lighter weight to reduce the whole weight of the shoe insole 10, thereby decreasing the burden to the user.

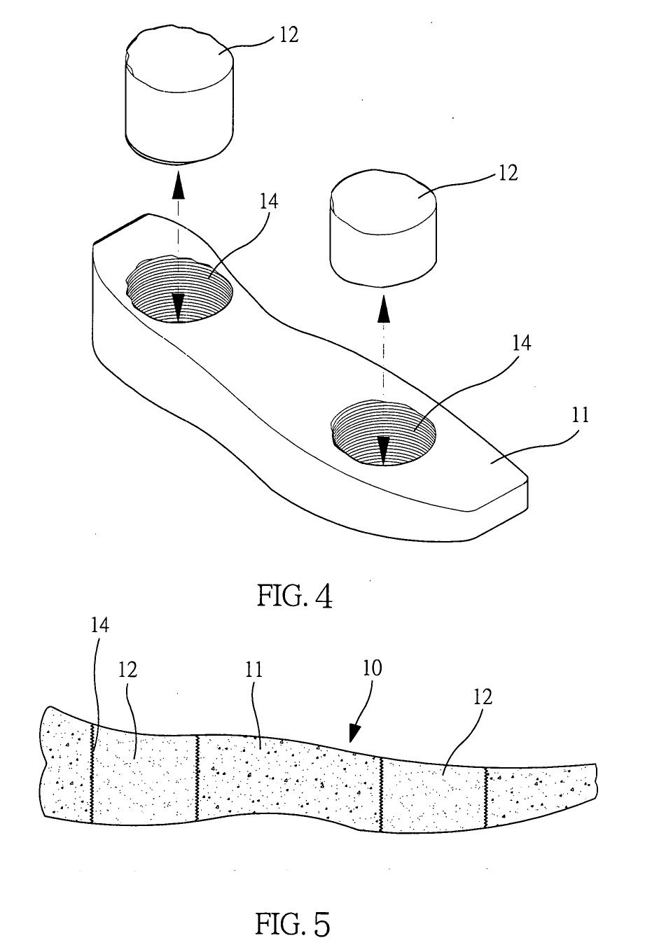

As shown in FIGS. 4 and 5, the bonding zone 14 is a through hole which is formed in an inside of the EVA material 11 and is extended through a whole thickness of the EVA material 11. Preferably, the EVA material 11 has two substantially circular bonding zones 14 located at front and rear portions of the EVA material 11 respectively, so that two solid PU materials 12 are located at the front and rear portions of the EVA material 11 respectively.

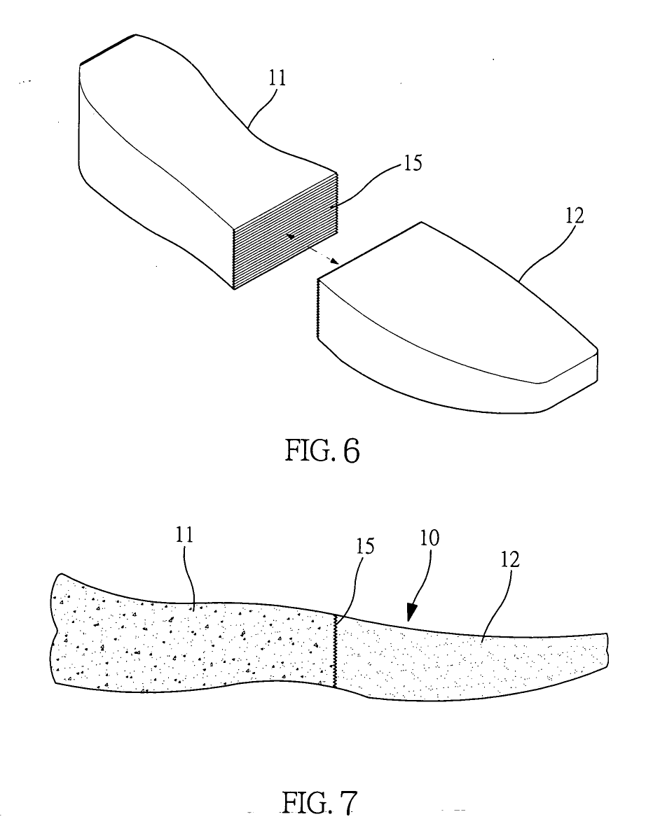

As shown in FIGS. 6 and 7, the bonding zone 15 is a transverse face which is formed on an end portion of the EVA material 11 and is extended through a whole thickness of the EVA material 11. Preferably, the EVA material 11 has a bonding zone 15 located at a rear portion of the EVA material 11, so that a solid PU material 12 is located at the rear portion of the EVA material 11.

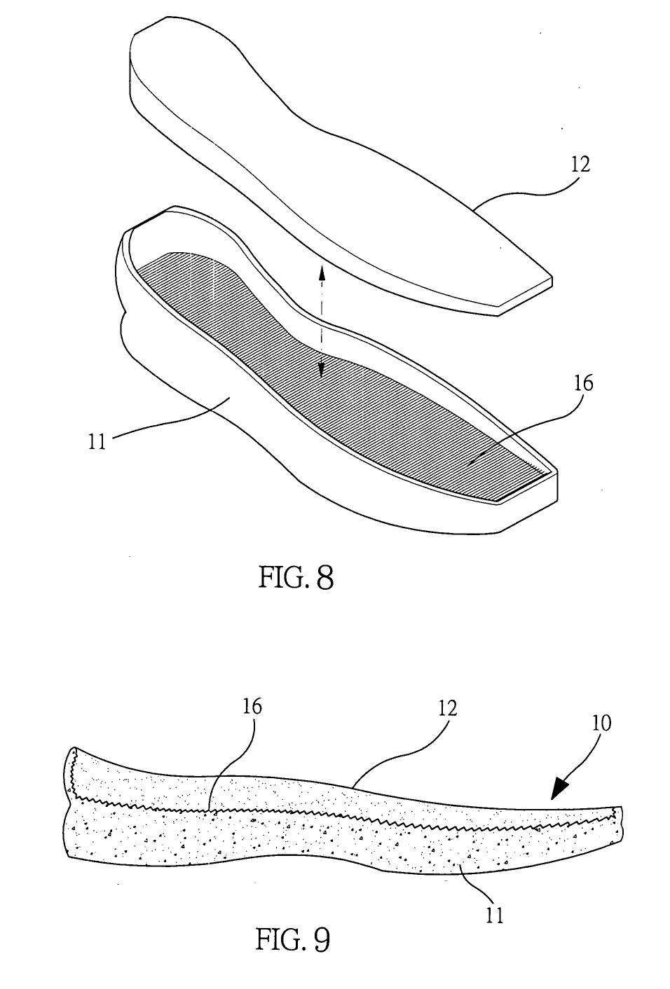

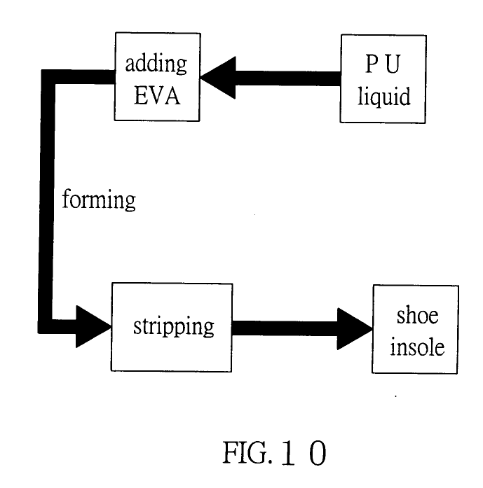

As shown in FIGS. 8 and 9, the bonding zone 16 is a groove which is formed in an inside of the EVA material 11 and is approximately extended through a whole length of the EVA material 11. Preferably, the EVA material 111 has a bonding zone 16 extended from a front portion to a rear portion of the EVA material 11, so that a solid PU material 12 is extended from the front portion to the rear portion of the EVA material 11.

Referring to FIG. 10, a method for manufacturing a composite shoe insole in accordance with another preferred embodiment of the present invention comprises the following steps:

a) placing PU material at a liquid state into a die;

b) providing EVA material having at least one bonding zone;

c) applying a PU film around a peripheral wall of the bonding zone of the EVA material;

d) heating the EVA material to a temperature at about 50° C. to 60° C.;

e) placing the EVA material into the die to mix with the PU material;

f) solidifying the PU material so that the PU material is combined with the bonding zone of the EVA material to form a shoe insole;

g) stripping the shoe insole from the die to remove the shoe insole which combines the EVA material and the PU material.

In the preferred embodiment of the present invention, the PU material is combined with the bonding zone of the EVA material by the PU film. In addition, the peripheral wall of the bonding zone of the EVA material has a rough surface, and the PU film is applied onto the rough surface of the bonding zone of the EVA material.

Accordingly, the solid PU material of the shoe insole provides a greater elastic support to a user's foot, thereby providing a comfortable sensation to the user. In addition, the EVA material of the shoe insole has a lighter weight to reduce the whole weight of the shoe insole, thereby decreasing the burden to the user. Further, the proportion, position and size of the EVA material and the PU material can be changed according to the practical requirement so as to provide a comfortable sensation to the user and to reduce the whole weight of the shoe insole, thereby enhancing the versatility of the shoe insole.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A method for manufacturing a composite shoe insole, comprising:
a) placing EVA (ethyl vinyl acetate) material into a die, wherein the EVA material has at least one bonding zone;
b) applying a PU (polyurethane) film around a peripheral wall of the bonding zone of the EVA material;
c) heating the EVA material;
d) placing PU material at a liquid state into the bonding zone of the EVA material;
e) solidifying the PU material so that the PU material is combined with the bonding zone of the EVA material to form a shoe insole;
f) stripping the shoe insole from the die to remove the shoe insole which combines the EVA material and the PU material.

2. The method in accordance with claim 1, wherein in the step c), the EVA material is heated to a temperature at about 50° C. to 60° C.

3. The method in accordance with claim 1, wherein the bonding zone is a recess which is formed in an inside of the EVA material.

4. The method in accordance with claim 3, wherein the recess is not extended through a whole thickness of the EVA material.

5. The method in accordance with claim 1, wherein the peripheral wall of the bonding zone of the EVA material has a rough surface, and the PU film is applied onto the rough surface of the bonding zone of the EVA material.

6. The method in accordance with claim 1, wherein the PU material is combined with the bonding zone of the EVA material by the PU film which functions as a bonding interface between the PU material and the bonding zone of the EVA material, so that the PU material is combined with the EVA material closely.

7. The method in accordance with claim 1, wherein the EVA material has two substantially bonding zones located at front and rear portions of the EVA material respectively, so that two solid PU materials are located at the front and rear portions of the EVA material respectively.

8. The method in accordance with claim 1, wherein the bonding zone is a through hole which is formed in an inside of the EVA material.

9. The method in accordance with claim 8, wherein the through hole is extended through a whole thickness of the EVA material.

10. The method in accordance with claim 1, wherein the bonding zone is a transverse face which is formed on an end portion of the EVA material.

11. The method in accordance with claim 10, wherein the transverse face is extended through a whole thickness of the EVA material.

12. The method in accordance with claim 1, wherein the EVA material has a bonding zone located at a rear portion of the EVA material, so that a solid PU material is located at the rear portion of the EVA material.

13. The method in accordance with claim 1, wherein the bonding zone is a groove which is formed in an inside of the EVA material.

14. The method in accordance with claim 13, wherein the groove is approximately extended through a whole length of the EVA material.

15. The method in accordance with claim 1, wherein the EVA material has a bonding zone extended from a front portion to a rear portion of the EVA material, so that a solid PU material is extended from the front portion to the rear portion of the EVA material.

16. The method in accordance with claim 1, wherein a proportion of the EVA material and the solid PU material is changeable.

17. A method for manufacturing a composite shoe insole, comprising:
a) placing PU material at a liquid state into a die;
b) providing EVA material having at least one bonding zone;
c) applying a PU film around a peripheral wall of the bonding zone of the EVA material;
d) heating the EVA material;
e) placing the EVA material into the die to mix with the PU material;
f) solidifying the PU material so that the P)U material is combined with the bonding zone of the EVA material to form a shoe insole;
g) stripping the shoe insole from the die to remove the shoe insole which combines the EVA material and the PU material.

18. The method in accordance with claim 17, wherein in the step d), the EVA material is heated to a temperature at about 50° C. to 60° C.

19. 1The method in accordance with claim 17, wherein the PU material is combined with the bonding zone of the EVA material by the PU film.

20. The method in accordance with claim 17, wherein the peripheral wall of the bonding zone of the EVA material has a rough surface, and the PU film is applied onto the rough surface of the bonding zone of the EVA material.
